(19) United States
(12) Patent Application Publication
(10) Pub. No.: US 2022/0101268 A1
(43) Pub. Date: Mar. 31, 2022

(54) AUTOMATED TASK SCHEDULING METHOD AND SYSTEM

(71) Applicant: Forty Two Labs Private Ltd, Singapore (SG)

(72) Inventors: Jin Hian Lee, Singapore (SG); Yee Yee Htut, Singapore (SG); Madhav Kumar Mishra, Singapore (SG)

(21) Appl. No.: 17/487,107

(22) Filed: Sep. 28, 2021

(30) Foreign Application Priority Data
Sep. 30, 2020 (SG) 10202009745R

(51) Int. Cl. G06Q 10/10; G06F 7/02

(52) U.S. Cl. CPC G06Q 10/1097; G06F 7/026

(57) ABSTRACT

An automated task scheduling method and system are provided. The method includes receiving a data input, wherein the data input is generated based on one or more user inputs; determining one or more slots based on the data input, wherein each slot comprises a date range and a time interval; scoring the one or more determined slots based on a set of parameters; ranking the scored slots; selecting one or more of the ranked slots based on rankings of the ranked slots; and generating a ranked list of slots based on the one or more selected slots.

### TECHNICAL FIELD

The present specification relates broadly, but not exclusively, to an automated task scheduling method and to an automated task scheduling system.

### BACKGROUND

Scheduling business meetings, interviews, calls etc. has become daily routines in organizations of any sizes. These meetings range from simple calls to complex calls that comprise multiple parties, span numerous locations and time zones, are conducted over many channels and require various resources like meeting rooms, dial-in bridges and online conferencing links.

The difficulty of identifying the most suitable set of time options increases with an increased number of intended participants and is typically a trade-off of many factors, including participants' role, seniority, availability, willingness to travel or work outside usual office hours, resource availability and so on.

On the surface, this might be a simple problem of having everyone keep their calendars up to date and provide some mechanism to share and optimally find a common time. However, in the real world, calendars are normally not sources of truths. Further, there are many soft preferences and organizational complexities to be taken into account when performing a scheduling task.

A need therefore exists to improve the manner in which task scheduling can be performed.

### SUMMARY

Embodiments seek to provide an automated task scheduling method and system that are autonomous and at the level of a human personal assistant.

According to a first aspect, there is provided an automated task scheduling method, comprising: receiving a data input, wherein the data input is generated based on one or more user inputs; determining one or more slots based on the data input, wherein each slot comprises a date range and a time interval; scoring the one or more determined slots based on a set of parameters; ranking the scored slots; selecting one or more of the ranked slots based on rankings of the ranked slots; and generating a ranked list of slots based on the one or more selected slots.

According to one embodiment, the data input may be further generated based on a scheduling task and/or roles of users.

According to another embodiment, the one or more user inputs may comprise a natural language and/or a user interface input.

According to another embodiment, determining the one or more slots may comprise: selecting one or more date ranges based on the data input; and selecting one or more time intervals based on the selected date ranges.

According to yet another embodiment, scoring the one or more determined slots may comprise generating one or more heat maps based on the set of parameters.

According to another embodiment, the set of parameters may comprise: a predefined buffer time associated with a user and an event type of a conflict event; and another predefined buffer time associated with the user and an event type of the scheduling task.

According to another embodiment, ranking the scored slots may comprise ranking scored slots within a same date range.

According to another embodiment, the automated task scheduling method may further comprise: presenting a subset of the ranked list of slots to one or more users; determining a preferred slot based on the subset of the ranked list of slots; and setting a task based on the preferred slot determined.

According to a second aspect, there is provided an automated task scheduling system, comprising: at least one processor; and a non-transitory computer-readable storage medium coupled to the at least one processor and storing programming instructions for execution by the at least one processor, the programming instructions instruct the at least one processor to perform any one of the methods described herein.

According to a third aspect, there is provided an automated task scheduling system, comprising a plurality of modules for performing any one of the methods described herein.

### BRIEF DESCRIPTION OF THE DRAWINGS

Embodiments are provided byway of example only, and will be better understood and readily apparent to one of ordinary skill in the art from the following written description, read in conjunction with the drawings, in which:

FIG. 1 is a schematic diagram illustrating an example of a scheduling assistant, according to an embodiment.

FIG. 2 is a flow chart illustrating an example of an automated scheduling method, according to an embodiment.

FIG. 3 is a schematic diagram illustrating an example of a scheduler, according to an embodiment.

FIG. 4 is a schematic diagram illustrating an example of a high level sequence of a scheduler, according to an embodiment.

FIG. 5 shows a table depicting an overview of search constraint generator, according to an embodiment.

FIG. 6 is a schematic diagram illustrating an example of a sequence for finding date ranges, according to an embodiment.

FIG. 7 is a schematic diagram illustrating an example of a sequence for finding time intervals, according to an embodiment.

FIG. 8 is a table illustrating an example of a time map, according to an embodiment.

FIG. 9 is a graph illustrating an example of a heat map, according to an embodiment.

FIG. 10 is a schematic diagram illustrating an example of a heat map, according to another embodiment.

FIG. 11 is a schematic diagram illustrating examples of combining heat maps, according to an embodiment.

FIG. 12 is a schematic diagram illustrating an example of combining heat maps, according to another embodiment.

FIG. 13 is a schematic diagram illustrating an example of a day constraint, according to an embodiment.

FIG. 14 is a schematic diagram illustrating an example of adding buffer time, according to an embodiment.

FIG. 15 is a schematic diagram illustrating an example of registering schedule conflicts, according to an embodiment.

FIG. 16 is a schematic diagram illustrating an example of registering schedule conflicts, according to another embodiment.

FIG. 17 is a schematic diagram illustrating an example of a sequence for ranking time intervals, according to an embodiment.

FIG. 18 is a schematic diagram illustrating an example of a sequence for selecting slots, according to an embodiment.

FIG. 19 shows a schematic diagram of a computer system suitable for use in executing at least some steps of the automated task scheduling method.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Scheduling business meetings, interviews, calls etc. has become daily routines in organizations of any sizes. These meetings range from simple calls to complex calls that comprise multiple parties, span numerous locations and time zones, are conducted over many channels and require various resources like meeting rooms, dial-in bridges and online conferencing links.

The difficulty of identifying the most suitable set of time options increases with an increased number of intended participants and is typically a trade-off of many factors, including participants' role, seniority, availability, willingness to travel or work outside usual office hours, resource availability and so on. Further, there are many soft preferences and organizational complexities to be taken into account when performing a scheduling task.

There may be tools available in the market that can assist with scheduling of tasks. However, the tools may not provide autonomous scheduling assistance at a preferred level such as at the level of a human personal assistant. The general problem may be one of coordination and collaboration between autonomous agents and their human environment in order to perform the scheduling of tasks. A deep knowledge of the real world environment such as people, time and locations (space-time), and how to interact with these factors in a flexible manner may be required. More nuances and dynamic interaction with the human environment need to be taken into consideration to improve the manner in which task scheduling can be performed.

According to one embodiment, a task scheduling engine that can be coupled with real-world knowledge from calendars and can be capable of balancing multiple factors concurrently to produce a ‘human-reasonable’ result is provided. Further, the task scheduling engine may be able to articulate why certain slots have been selected or recommended, or may not be suitable but are the best available options.

According to another embodiment, a system of intelligence that uses the conversational and coordination primitives to become a generalized autonomous agent system capable of performing routine business and/or personal coordination tasks is provided. Autonomous scheduling may be achieved with the system.

According to some implementations, the system can receive rich natural language input. In other words, the system may have the ability to receive natural language input from various participants/users and apply reasoning to select optimal slots automatically. Further, the system may allow respondents to provide responses not just for themselves, but also for others. For example, personal assistants who work for senior participants/users can respond on behalf of the senior participants/users. As another example, a single person can respond on behalf of a team of people whom he/she just communicated with.

Further, the system may include a scheduling engine capable of handling real-world scenarios. The scheduling engine may comprise scalable architecture that allows consideration of an unlimited number of factors and dimensions in performing the tasks of scoring and ranking slots. The scheduling engine may also comprise an extensible framework to create strategies to be used in various scenarios depending on the specific scheduling task, roles of participants/users and any other factors. For example, macro action spaces such as expanding search ranges or negotiating with a sub-group of participants/users, and the reasoning mechanisms to decide when to use each, may be created. There may be no requirement for participants/users to use any calendaring system. In other words, the scheduling engine can take expressed preferences via natural language, user interface (UI) or other methods and perform preference fusion. Further, the scheduling engine may allow multiple participants/users to provide various date ranges and/or time intervals, and can determine and rank common slots. The common slots can be preferred common slots. The scheduling engine can also maintain a memory of available alternatives to fall back on. The available alternatives can be preferred available alternatives. The scheduling engine can also perform batch scheduling such as setting up multiple meetings concurrently by determining/approving multiple suitable times bounded by minimum and maximum slots.

In addition, the system may include a cognitive collaboration system. The cognitive collaboration system may be able to interact and negotiate with participants/users with multiple iterations using flexible negotiation and clarification strategies. The cognitive collaboration system may also be able to coordinate and/or communicate with human personal assistants who perform coordination work on behalf of their principals.

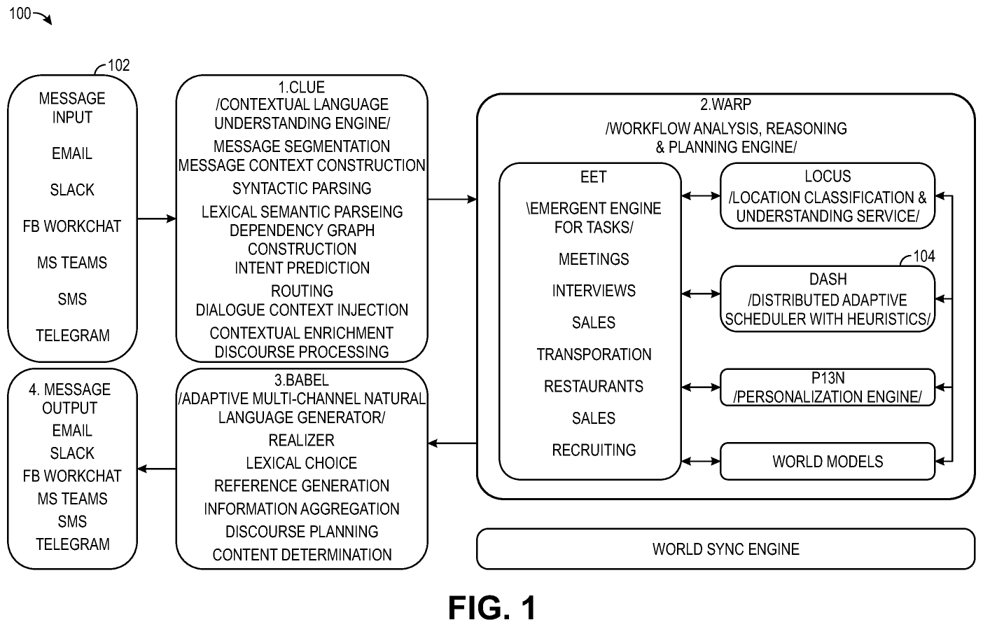

FIG. 1 is a schematic diagram illustrating an example of a scheduling assistant 100, according to an embodiment. The scheduling assistant 100 may autonomously perform scheduling of tasks such as meetings, calls, break times, etc. based on an input 102. The input 102 can be a combination of natural language and/or user interface (UI) input.

For example, the scheduling assistant 100 may be able to receive input 102 in the form of natural language across different channels and/or UIs to capture instructions or intents of the users. As an example, the inputs 102 can be an organizer's requirements (e.g. a sentence such as “please schedule a call for us tomorrow”) or responses from other participants/users (e.g. a sentence such as “Monday works for me. I'm in New York”). Further, the scheduling assistant 100 may be able to reason from the inputs 102 or interpret the inputs 102 to infer instructions and facts, and maintain a state of the world, so as to make decisions regarding the next course of action(s) for achieving the aims of the tasks. The scheduling assistant 100 may also be able to schedule tasks based on imperfect information and iteratively discover and build consensus towards common slots. In addition, the scheduling assistant 100 may be able to interact and collaborate with the participants/users and take into consideration resources involved in a task in order to dynamically discover solutions.

The scheduling assistant 100 may comprise a scheduler 104. The scheduler 104 can fuse or combine various factors from multiple users/participants to achieve the function of proposing, negotiating and accepting reasonable, human-like slots across various iterations. Autonomous scheduling may be achieved.

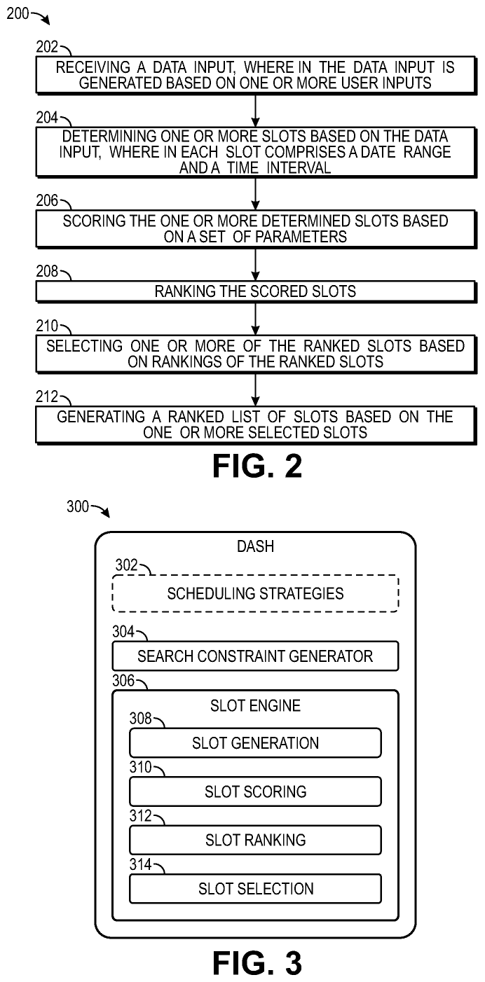

FIG. 2 is a flow chart 200 illustrating an example of an automated scheduling method, according to an embodiment. At step 102, a data input is received. The data input is generated based on one or more user inputs. At step 104, one or more slots is determined based on the data input. Each slot comprises a date range and a time interval. At step 106, the one or more determined slots are scored based on a set of parameters. At step 108, the scored slots are ranked. At step 110, one or more of the ranked slots are selected based on rankings of the ranked slots. At step 112, a ranked list of slots is generated based on the one or more selected slots.

According to some implementations, each slot can also comprise location. In other words, each slot can comprise a date range, a time interval and/or a location.

According to one embodiment, the data input can be further generated based on a scheduling task and/or roles of users.

The one or more user inputs may comprise a natural language and/or a user interface input.

According to some implementations, determining the one or more slots may comprise selecting one or more date ranges based on the data input and selecting one or more time intervals based on the selected date ranges.

Scoring the one or more determined slots may comprise generating one or more heat maps based on the set of parameters.

The set of parameters may comprise a predefined buffer time associated with a user and an event type of a conflict event and another predefined buffer time associated with the user and an event type of the scheduling task.

Ranking the scored slots may comprise ranking scored slots within a same date range.

According to some implementations, the automated task scheduling method may further comprise presenting a subset of the ranked list of slots to one or more users, determining a preferred slot based on the subset of the ranked list of slots, and setting a task based on the preferred slot determined.

For example, a subset of the ranked list of slots can be presented to one or more of the intended participants for scheduling, or if a satisfactory slot has been found, accepting it and confirming the meeting or task at that slot.

FIG. 3 is a schematic diagram illustrating an example of a scheduler 300, according to an embodiment. The scheduler 300 may comprise a search constraint generator 304 and a slot engine 306. The slot engine 306 may comprise a slot generation module 308, a slot scoring module 310, a slot ranking module 312 and a slot selection module 314. The scheduler may further comprise scheduler strategies 302.

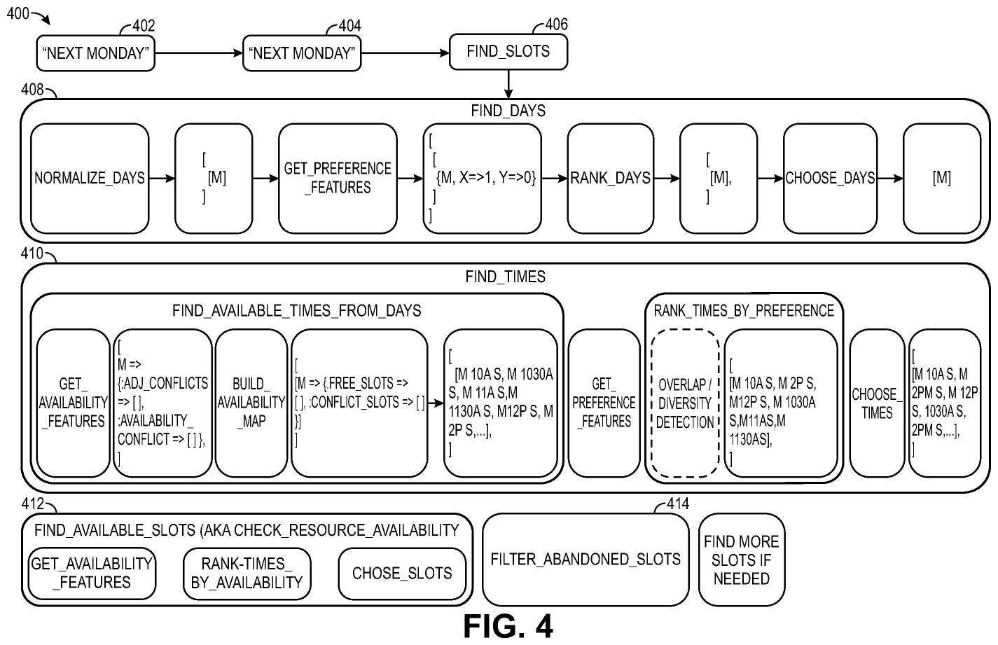

FIG. 4 is a schematic diagram 400 illustrating an example of a high level sequence of a scheduler, according to an embodiment. Inputs 402, 404 may be received by the scheduler. A set of instructions to find slots 406 may be executed based on the inputs 402, 404. Another set of instructions to find days/date ranges 408 may be executed thereafter. A set of instructions to find time intervals 410 may then be executed. Another set of instructions to find available slots or check availability of resources 412 may then be executed. A set of instructions to filter slots 414 may be executed thereafter. The scheduler may execute one or more sets of instructions 406, 408, 410, 412, 414 to find more slots.

The scheduler strategies can be an extensible framework for creating strategies to be used in various scenarios depending on the specific scheduling task, roles of participants and any other factors. The scheduler strategies can be used to control the behaviour of the search constraint generator and the slot engine by setting specific attributes, combining the results of multiple runs for various constraints or for different groups of users/participants depending on higher-order goals. For example, the specific attributes can be minimum number of slots that are required; whether the scheduler hide slots with availability conflicts, and if so, for which participants; an explicit list of slots that the scheduling engine should not return as valid; and whether the scheduler should automatically go beyond the original search range if no viable candidate times or common slots can be found.

As mentioned above, the scheduler may comprise a search constraint generator and a slot engine.

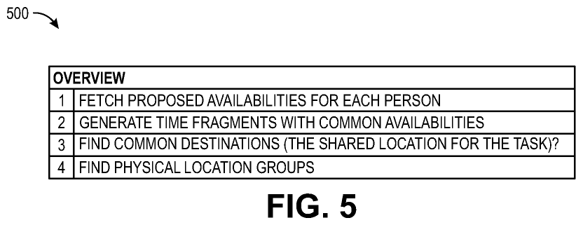

FIG. 5 shows a table 500 depicting an overview of search constraint generator, according to an embodiment. The search constraint generator may be a component or module for generating search ranges based on composite participant inputs, requirements and/or responses. A search range or constraints can be based on user requests, preferences, context, etc.

The slot engine may be a component or system for generating, scoring and ranking slots within the search range while optimizing quality and performance of the component or system.

As mentioned above, the slot engine may comprise a slot generation module, a slot scoring module, a slot ranking module and a slot selection module.

The slot generation module may use an algorithm to optimize the generation or determination of high-probability slots so that the number of slots to be considered can be minimized for better performance, without any hard-coded rules or arbitrary assumptions about working days or user preferences. Slot generation may be based on or guided by the search range/constraints and/or preferences. For example, slots falling on public holidays may not be generated if other days are available to be considered. As another example, if the users prefer to only consider public holidays, then those slots may be generated accordingly.

The slot generation module may receive input from the search constraint generator. Input generated by the search constraint generator may provide discrete constraints such as a date range (e.g. “next week” or “next Monday”). Multiple constraints may also be provided. For example, a time constraint can be applied to a date range (e.g. “next week 10 am” or “next week 4 pm”).

Firstly, the slot engine may break down the constraints into a ranked set of days or periods via a series of steps.

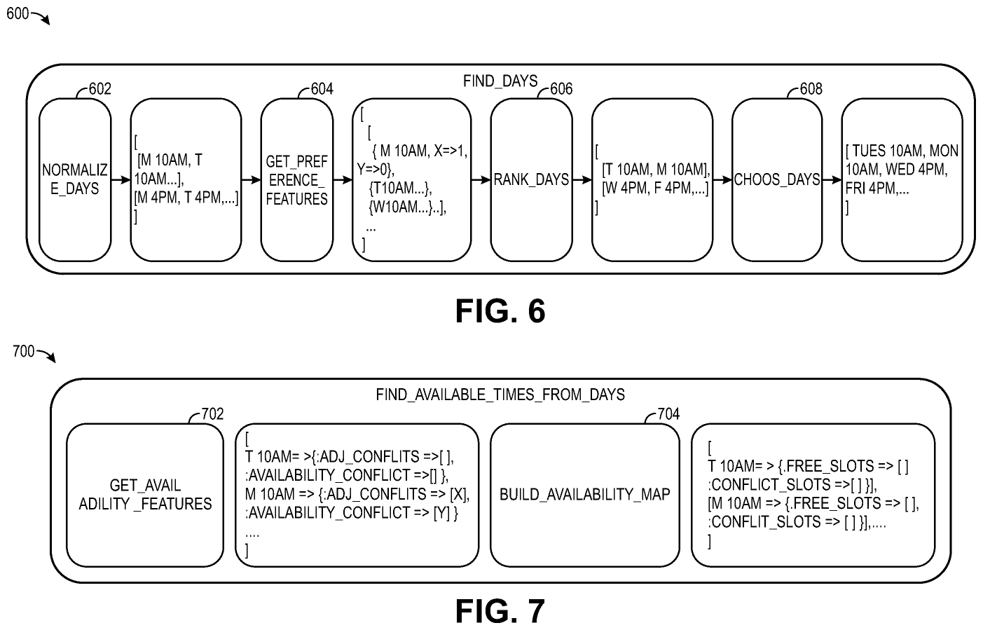

FIG. 6 is a schematic diagram 600 illustrating an example of a sequence for finding date ranges, according to an embodiment. The sequence may comprise a normalize_days step 602, a get_preference_features step 604, a rank_days step 606 and a choose_days step 608. At each step, a set of instructions may be executed.

The normalize_days step 602 may break down the constraints into daily buckets. The choice of a daily bucket size can be arbitrary and can be chosen to trade off system performance against granularity for ranking in downstream steps. For example, buckets can be defined as half-days or a week instead of days. All references to “days” should be read as the arbitrary bucket period chosen at this step. In all figures, content within a bucket is denoted by [ . . . ] (e.g. [Mon 10 am, Mon 1030 am, . . . Mon 4 pm, . . . ], [Tues 10 am, Tues 11 am, Tues 4 pm . . . ]).

The get_preference_features step 604 can generate preference features scores (more details provided below) for all the constraints at day level so the slot engine can prioritize preferred days for initial processing at a relatively fast speed. Examples of the instructions can be {Mon 10 am, :weekday=>1, :public_holiday=>0, :feature_n=>X . . . }, {Tues 10 am, :weekday=>1, :public_holiday=>0, :feature_n=>Y . . . }, {Mon 4 pm, :weekday=>1, :public_holiday=>0, :feature_n=>XX . . . } and {Tues 4 pm, :weekday=>1, :public_holiday=>0, :feature_n=>YY . . . }.

The rank_days step 606 may arrange the days in priority order, with a series of customized rules that take into account desired preference features. For example, depending on the nature of the event being scheduled, weekdays may be preferred over weekends or public holidays, or vice versa. The slot engine can provide relatively high level of flexibility and without making hard built-in assumptions. Ranking can be done on a per-use basis, without requirements for special rules and with any given set of criteria. In this manner, support can be provided for weekends to be prioritized for certain types of events (e.g. social events), weekdays to be prioritized for other types of events (e.g. work events) and reducing the rank of days where users/participants are already busy. Support can also be provided for multiple participants who have different days of week designated as weekends (e.g. Fridays and Saturdays are weekends in some parts of the world). Further, there can be support for diversity (e.g. if Monday is the highest ranked, then the next highest rank may be Thursday instead of Tuesday, assuming all other factors are equal) so that the scheduler can propose a more mixed range of options.

The choose_days step 608 can then select the top ranked days for downstream slot processing. By choosing only higher ranking days upstream, the number of timeslots to be considered by downstream slot scoring and ranking can be reduced. The downstream slot scoring and ranking can be computationally expensive. In this manner, the slot engine can perform at a faster speed and can be scaled to cater for real-time behaviour.

The slot engine may then process each chosen day via a series of steps in order to generate slots to be considered.

FIG. 7 is a schematic diagram 700 illustrating an example of a sequence for finding time intervals, according to an embodiment. The sequence may comprise a get_availability_features step 702 and a build_availability_map step 704.

The get_availability_features step 702 may check the availability of users/participants and resources for each time period and determine if there are any conflicts (e.g. [Mon 10 am=>{:adj_conflicts=>[ ], :availability_conflict=>[ ]}, Tues, 10 am=>{:adj_conflicts=>[X], :availability_conflict=>[Y]} . . . ]).

The build_availability_map step 704 may convert constraints into actual slots of the desired duration, with the start and end time, and bucketing them into the slots that are free or have availability conflicts (e.g. [[Mon 10 am=>{:free_slots=>[ . . . ] . . . , :conflict_slots=>[ . . . ]} ], [Tues 10 am=>{:free_slots=>[ . . . ] . . . , :conflict_slots=>[ . . . ]}], . . . ]).

As mentioned above, the slot engine may comprise a slot generation module, a slot scoring module, a slot ranking module and a slot selection module.

The slot scoring module may supplement slots generated by the slot generation module as described above with necessary data and then scoring each slot against individual factors, features and/or dimensions. A method for representing and using time-based preferences and/or desirability factors can be based on time maps, time zones and heat maps. For example, for an event type, a time map can be obtained. The time map can be a floating time map. The time map can be integrated with or mapped to time zone(s) to generate a heat map.

A series of floating time maps for certain preferences which are independent of calendar date can be created for and/or selected using any combination of days of a week, day number, week number, month number, type of meeting/event/task, location, date range, etc.

The floating time maps can be of a desired granularity, from minutes to hours to weeks as appropriate and can cover any period that is appropriate. Preferences in the floating time maps may be expressed as a fraction between −1 and 1 and a desired scaling factor, symmetric or otherwise, can be applied. Generally, time maps can be ideal for representing preferences that repeat on a periodic basis independent of a specific day and the weight for each granular slot (e.g. no meetings on Mondays, night calls allowed but only if needed).

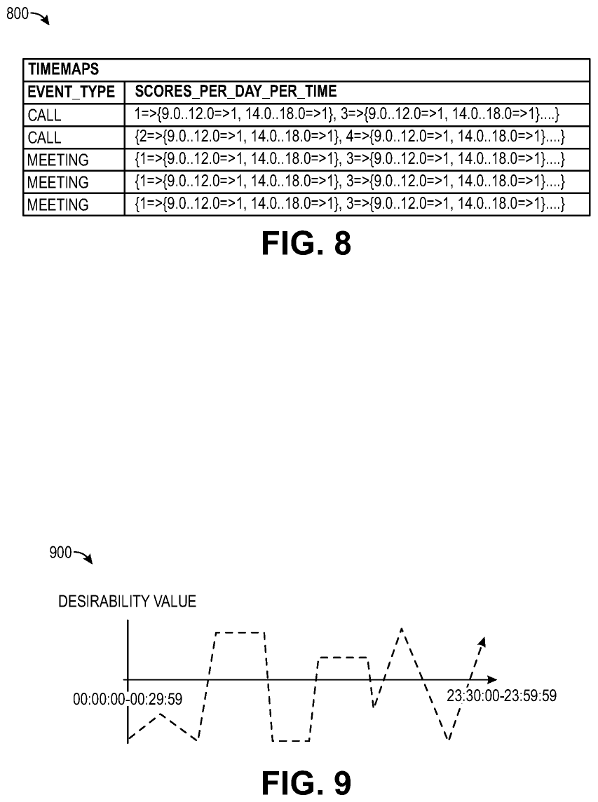

FIG. 8 is a table 800 illustrating an example of a time map, according to an embodiment.

When performing a scheduling task, the time maps can be applied or mapped to specific date ranges to generate preference feature heat maps that are fixed to specific time intervals.

FIG. 9 is a graph 900 illustrating an example of a heat map, according to an embodiment. As shown in the graph 900, time is plotted against desirability value.

Heat maps may also be generated directly depending on the nature of the features that they represent. For example, an availability heat map may be derived directly from calendar availability for the times under consideration. Generally, heat maps and their source time maps, if any, can be a useful tool to represent, score and weigh many different types of preference features or parameters on a per-user basis simultaneously. The preference features or parameters may comprise calendar availability, explicit user-input availability (e.g. a sentence such as “I'm free on Monday” or an input via a UI) or expressed availability, time zone and/or working hours on a per-individual basis, time zone and/or time preference desirability, coarse location, fine location (e.g. travel time), location desirability, buffer time, notice period, events per day (e.g. one lunch per day), abandoned slot(s) and/or multiple cities slot.

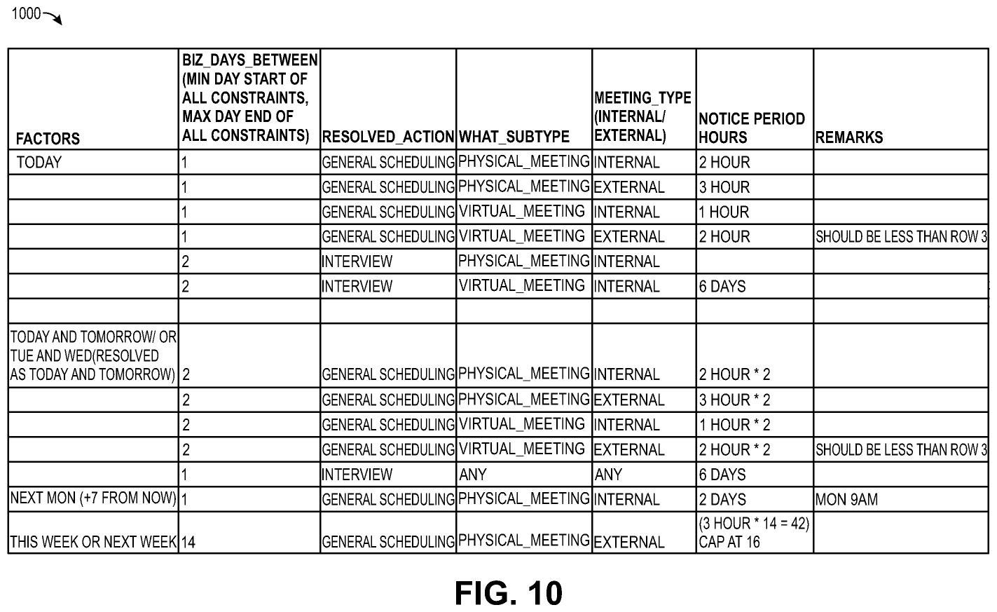

FIG. 10 is a schematic diagram 1000 illustrating an example of a heat map, according to another embodiment.

Heat maps for each preference feature or dimension for individual users can be generated. Based on the generated heat maps, the slot engine can assess or determine how suitable or preferable a particular slot is for a given user and a preference feature. Multiple heat maps can also be aggregated to generate a new composite preference feature score.

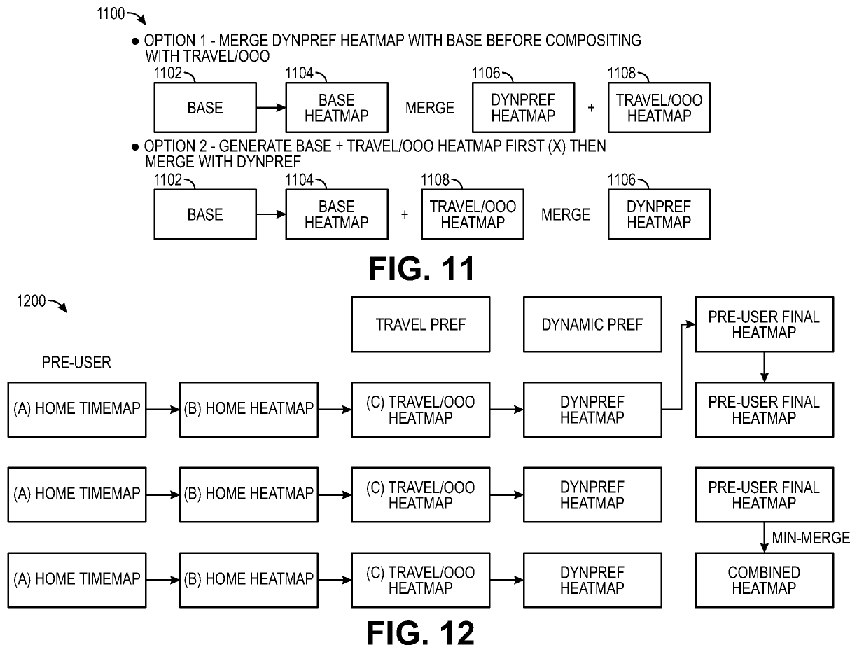

FIG. 11 is a schematic diagram 1100 illustrating examples of combining heat maps, according to an embodiment. Base heat maps 1104 may be generated based on base information or data 1102. One example of combining heat maps can be merging or combining dynamic preference heat map(s) 1106 with base heat map(s) 1104 before combining with travel/out of office heat map(s) 1108. Another example of combining heat maps can be merging or combining travel/out of office heat map(s) 1108 with base heat map(s) 1104 before combining with dynamic preference heat map(s) 1106. Generally, it may be preferred to merge or combine travel/out of office heat map(s) 1108 with base heat map(s) 1104 before combining with dynamic preference heat map(s) 1106 since if the user is travelling, dynamic preference heat map(s) 1106 should override travelout of office heat map(s) 1108.

FIG. 12 is a schematic diagram 1200 illustrating an example of combining heat maps, according to another embodiment. The scores for a given slot and preference feature can be aggregated using a custom aggregation function across each individual heat map score for that preference feature at the time of the slot. This aggregation function can be a mathematical (e.g. minimum, maximum, average, etc.) or statistical (e.g. trained model) model or function or any other aggregation approach that is appropriate to the preference feature. This allows the system to understand the overall suitability or preference for a given slot for that preference feature, across all the individual users.

Each slot may then be supplemented with the individual and aggregate scores for that feature so they are then available to be used to generate an aggregate preference feature score for that slot, with a custom aggregation function, with different weights and/or with a statistical algorithm.

Slots can also have scores that are a due to a feature of the slot itself, independent of any user (e.g. {:score=>0.5, :conflict=>{:type=>:weekend, users=>[ ], :conflict_specific_feature=> . . . }).

Further, slots may also be supplemented with other information and attributes that are not represented by a score but can be used by higher-level decision-making engines.

As mentioned above, preference features or parameters may comprise buffer time. In order to compute buffer time, availability map(s) may be calculated.

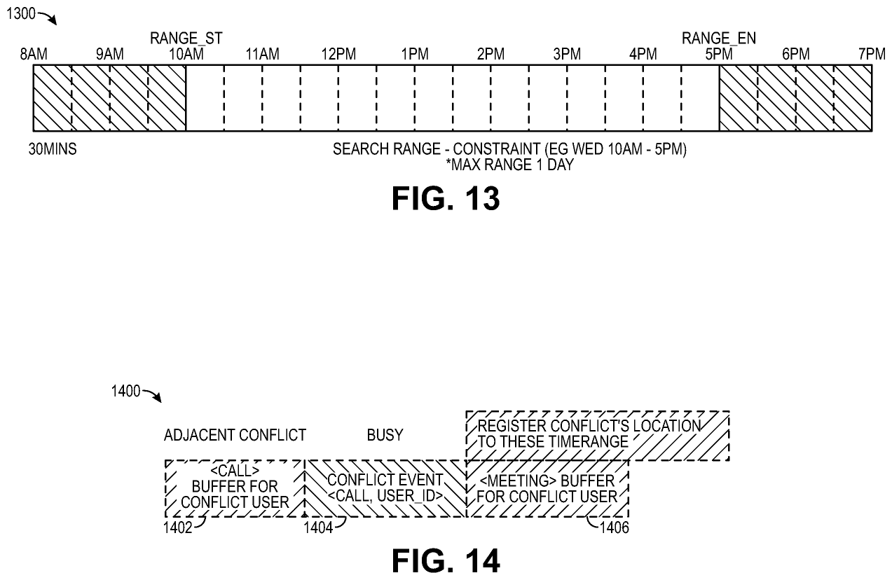

FIG. 13 is a schematic diagram 1300 illustrating an example of a day constraint, according to an embodiment. The day constraint may be broken down into 30 minutes slots and conflict events for constraints may be queried at ±2 hours (max buffer time).

FIG. 14 is a schematic diagram 1400 illustrating an example of adding buffer time, according to an embodiment. There may be 2 buffers to be considered for a conflict event 1404—conflict event's buffer 1402 and scheduling event's buffer 1406. The conflict event's buffer 1402 can be based on the conflict event's 1404 event type and preference buffer time of the particular user. The buffer time can be added before the conflict event 1404. The scheduling event's buffer 1406 can be based on the event type of the current scheduling task and preference buffer time of the particular user. The buffer time can be added after the conflict event 1404.

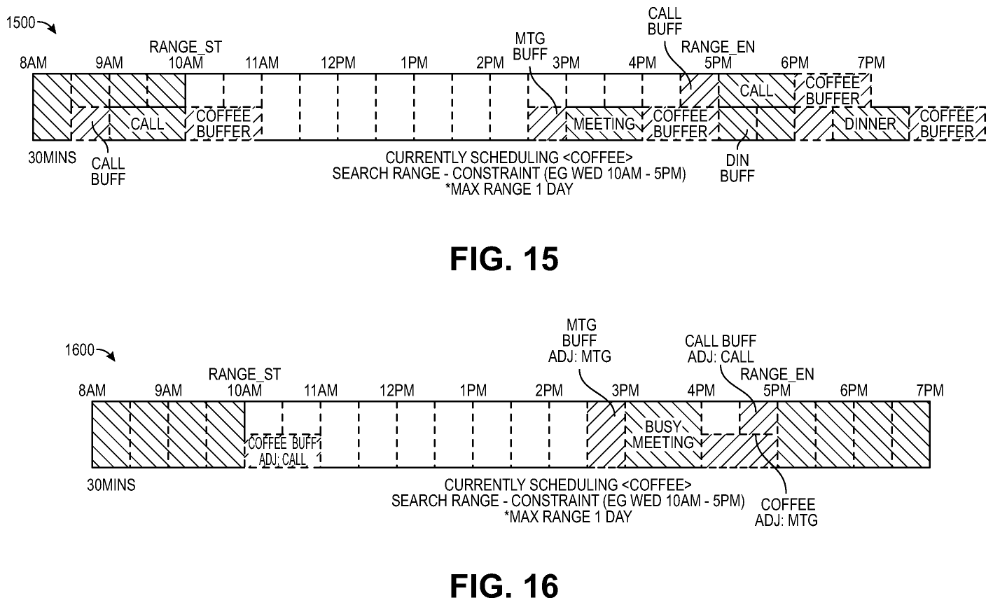

FIG. 15 is a schematic diagram 1500 illustrating an example of registering schedule conflicts, according to an embodiment.

FIG. 16 is a schematic diagram 1600 illustrating an example of registering schedule conflicts, according to another embodiment.

As mentioned above, the slot engine may comprise a slot generation module, a slot scoring module, a slot ranking module and a slot selection module.

The slot ranking module may comprise ranking the slots within a day or bucket period according to various factors, with the goal of providing a preferred list of slots for that given period.

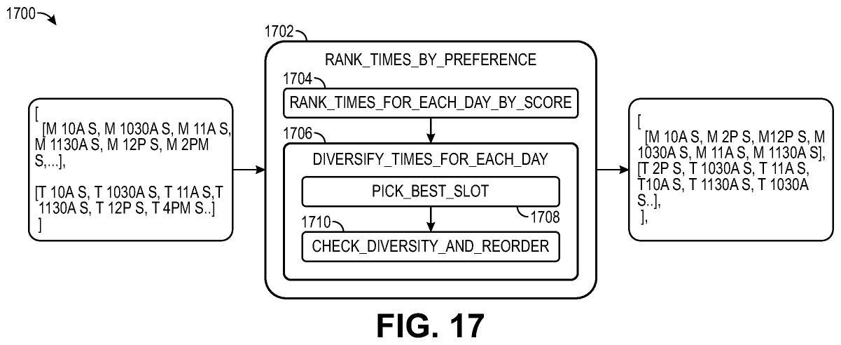

FIG. 17 is a schematic diagram 1700 illustrating an example of a sequence for ranking time intervals, according to an embodiment. The slot ranking module 1702 may comprise a module to rank slots within each day or bucket 1704 and another module to diversify times for each day 1706. The module to diversify times for each day 1706 may comprise a sub-module to pick preferred slots 1708 and a sub-module to check diversity and reorder slots 1710. Each of the modules and sub-modules may comprise a set of instructions to be executed.

Slots within each day or bucket may be ranked according to their aggregate scores and/or any other sub-scores as desired.

Thereafter, within each bin of ranked slots, iterative steps may be performed to pick or select the preferred slot based on the aggregate score that has been assigned to the slot by the slot scoring module. This step can comprise a single iteration which slots are picked in order of or based on their scores. However, in this manner, there may be scenarios such as two slots with the highest scores may overlap with each other (e.g. 2 pm-245 pm and 230 pm-315 pm) or the slots may all be in the morning (e.g. 8 am and 9 am) even if some afternoon slots are available. While technically both slots may be viable, this may be counter to expected human behaviour when scheduling and can result in sub-optimal performance due to the need for further back-and-forth interactions.

The sub-module to check diversity and reorder slots may be used to improve the scheduling. After a preferred slot has been picked, net slot(s) can be picked and re-ranked based on additional criteria such as overlap, time distance, location, etc. that apply relative to the first slot picked. For example if the first slot picked is at 9 am, although the next preferred slot according to aggregate score may be at 10 am, the system may down-rank that slot and pick the next slot from the list, favouring 2 pm as an example. In this manner, the system can achieve diversity of slots within each day or bucket period.

As mentioned above, the slot engine may comprise a slot generation module, a slot scoring module, a slot ranking module and a slot selection module.

The slot selection module may generate a flat, ranked list of slots as the output of the slot engine.

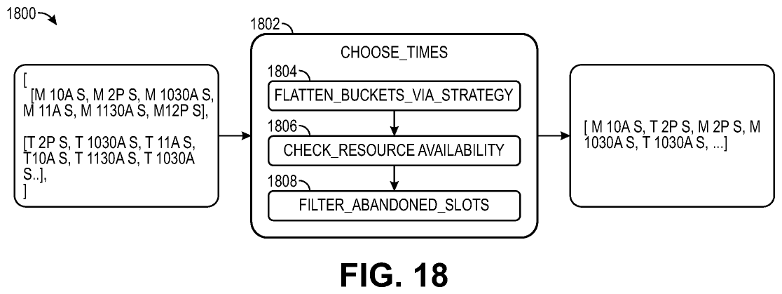

FIG. 18 is a schematic diagram 1800 illustrating an example of a sequence for selecting slots, according to an embodiment. The slot selection module 1802 may comprise a sub-module to flatten buckets 1804, a sub-module to check resource availability 1806 and a sub-module to filter abandoned slots 1808. The slot selection module 1802 and each of the sub-modules may comprise a set of instructions to be executed.

The slot selection module 1802 may flatten the buckets by selecting slots across each day or bucket period in order to achieve diversity across each day or bucket period. This flattening can be executed using straightforward strategies like round-robin (pick the most preferred slot from each bucket, then repeat) or more complex strategies that may involve their own diversity detection or other arbitrary criteria. This allows the scheduling system or slot engine to offer human-sensible options for a given query. For example, a system without this step may, based on aggregate scores, rank Monday 9 am and Monday 2 pm as the two top options. However, with this inter-day diversity selection process, the slot engine can instead offer Monday 9 am and Thursday 2 pm as the two top options, thereby delivering a wider spread of options.

After the preliminary flat ranked list of slots has been generated, there can be additional filtering and ranking processes based the selected strategies. The top-ranked slots may be checked against factors such as external resource availability, previously-suggested slots and/or other criteria. The slots may then be annotated and discarded, or down-ranked depending on the desired output. Filters applied at this stage can be, but not necessarily, resource-intensive or expensive by some metric such as CPU, bandwidth, time. This multi-stage approach can also allow the system or slot engine to only apply these filters to the most desirable or preferred ranked slots.

Further, if there are insufficient viable slots to meet the required minimum number of slots as per the scheduler strategy, the system or slot engine may repeat the steps of slot ranking, slot scoring, slot generation (up to the highest level as necessary) in order to generate more alternatives.

The multi-stage approach as described can allow the system or slot engine to scale to consider larger time or date ranges with a large number (e.g. thousands) of slots that can otherwise be computationally expensive, by prioritizing features in the earlier stages to reduce the number of potential slots that can then be checked more exhaustively.

According to some implementations, a location classification and understanding system may also be provided. Given a piece of text, the system may detect or determine if the piece of text can be interpreted as a location. The system can identify both universal anchored locations (such as addresses, web conference links, etc.) as well as contextually-unique locations (such as meeting room names or office names within an organizational context). The locations can be annotated with the type of location, supplementary data from external data providers (EDPs) and/or approximate geolocation data either from internal knowledge or EDPs.

According to one embodiment, an automated task scheduling system is provided. The automated task scheduling system comprises at least one processor and a non-transitory computer-readable storage medium coupled to the at least one processor and storing programming instructions for execution by the at least one processor, the programming instructions instruct the at least one processor to perform any of the methods described above.

According to another embodiment, another automated task scheduling system is provided. The automated task scheduling system comprises a plurality of modules for performing any of the methods described above.

The plurality of modules may comprise a receiving module configured to receive a data input. The data input can be generated based on one or more user inputs. The plurality of modules may also comprise a slot determining module configured to determine one or more slots based on the data input. Each slot may comprise a date range and a time interval. Further, the plurality of modules may comprise a scoring module configured to score the one or more determined slots based on a set of parameters. The plurality of modules may also comprise a ranking module configured to rank the scored slots. In addition, the plurality of modules may comprise a slot selecting module configured to select one or more of the ranked slots based on rankings of the ranked slots. The plurality of modules may also comprise a slot list generating module configured to generate a ranked list of slots based on the one or more selected slots.

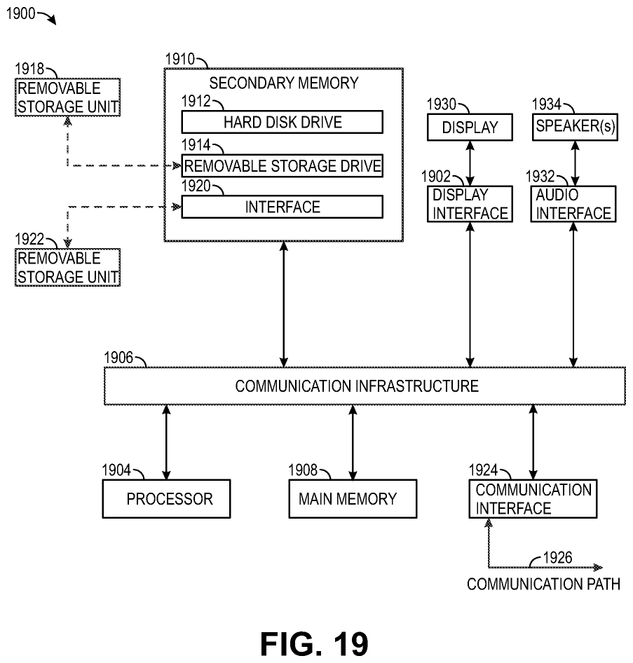

FIG. 19 shows a schematic diagram of a computer system suitable for use in executing at least some steps of the automated task scheduling method.

The following description of the computer system/computing device 1900 is provided by way of example only and is not intended to be limiting.

As shown in FIG. 19, the example computing device 1900 includes a processor 1904 for executing software routines. Although a single processor is shown for the sake of clarity, the computing device 1900 may also include a multi-processor system. The processor 1904 is connected to a communication infrastructure 1906 for communication with other components of the computing device 1900. The communication infrastructure 1906 may include, for example, a communications bus, cross-bar, or network.

The computing device 1900 further includes a main memory 1908, such as a random access memory (RAM), and a secondary memory 1910. The secondary memory 1910 may include, for example, a hard disk drive 1912 and/or a removable storage drive 1914, which may include a magnetic tape drive, an optical disk drive, or the like. The removable storage drive 1914 reads from and/or writes to a removable storage unit 1918 in a well-known manner. The removable storage unit 1918 may include a magnetic tape, optical disk, or the like, which is read by and written to by removable storage drive 1914. As will be appreciated by persons skilled in the relevant art(s), the removable storage unit 1918 includes a computer readable storage medium having stored therein computer executable program code instructions and/or data.

In an alternative embodiment, the secondary memory 1910 may additionally or alternatively include other similar devices for allowing computer programs or other instructions to be loaded into the computing device 1900. Such devices can include, for example, a removable storage unit 1922 and an interface 1920. Examples of a removable storage unit 1922 and interface 1920 include a removable memory chip (such as an EPROM or PROM) and associated socket, and other removable storage units 1922 and interfaces 1920 which allow software and data to be transferred from the removable storage unit 1922 to the computer system 1900.

The computing device 1900 also includes at least one communication interface 1924. The communication interface 1924 allows software and data to be transferred between computing device 1900 and external devices via a communication path 1926. In various embodiments, the communication interface 1924 permits data to be transferred between the computing device 1900 and a data communication network, such as a public data or private data communication network. The communication interface 1924 may be used to exchange data between different computing devices 1900 which such computing devices 1900 form part an interconnected computer network. Examples of a communication interface 1924 can include a modem, a network interface (such as an Ethernet card), a communication port, an antenna with associated circuitry and the like. The communication interface 1924 may be wired or may be wireless. Software and data transferred via the communication interface 1924 are in the form of signals which can be electronic, electromagnetic, optical or other signals capable of being received by communication interface 1924. These signals are provided to the communication interface via the communication path 1926.

Optionally, the computing device 1900 further includes a display interface 1902 which performs operations for rendering images to an associated display 1930 and an audio interface 1932 for performing operations for playing audio content via associated speaker(s) 1934.

As used herein, the term “computer program product” may refer, in part, to removable storage unit 1918, removable storage unit 1922, a hard disk installed in hard disk drive 1912, or a carrier wave carrying software over communication path 1926 (wireless link or cable) to communication interface 1924. Computer readable storage media refers to any non-transitory tangible storage medium that provides recorded instructions and/or data to the computing device 1900 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 1900. Examples of transitory or non-tangible computer readable transmission media that may also participate in the provision of software, application programs, instructions and/or data to the computing device 1900 include radio or infra-red transmission channels as well as a network connection to another computer or networked device, and the Internet or Intranets including e-mail transmissions and information recorded on Websites and the like.

The computer programs (also called computer program code) are stored in main memory 1908 and/or secondary memory 1910. Computer programs can also be received via the communication interface 1924. Such computer programs, when executed, enable the computing device 1900 to perform one or more features of embodiments discussed herein. In various embodiments, the computer programs, when executed, enable the processor 1904 to perform features of the above-described embodiments. Accordingly, such computer programs represent controllers of the computer system 1900.

Software may be stored in a computer program product and loaded into the computing device 1900 using the removable storage drive 1914, the hard disk drive 1912, or the interface 1920. Alternatively, the computer program product may be downloaded to the computer system 1900 over the communications path 1926. The software, when executed by the processor 1904, causes the computing device 1900 to perform functions of embodiments described herein.

It is to be understood that the embodiment of FIG. 19 is presented merely by way of example. Therefore, in some embodiments one or more features of the computing device 1900 may be omitted. Also, in some embodiments, one or more features of the computing device 1900 may be combined together. Additionally, in some embodiments, one or more features of the computing device 1900 may be split into one or more component parts.

This specification uses the term “configured to” in connection with systems, devices, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An automated task scheduling method, comprising:
receiving a data input, wherein the data input is generated based on one or more user inputs;
determining one or more slots based on the data input, wherein each slot comprises a date range and a time interval;
scoring the one or more determined slots based on a set of parameters;
ranking the scored slots;
selecting one or more of the ranked slots based on rankings of the ranked slots; and
generating a ranked list of slots based on the one or more selected slots.

2. The method as claimed in claim 1, wherein the data input is further generated based on a scheduling task and/or roles of users.

3. The method as claimed in claim 1, wherein the one or more user inputs comprise a natural language and/or a user interface input.

4. The method as claimed in claim 1, wherein determining the one or more slots comprises:
selecting one or more date ranges based on the data input; and
selecting one or more time intervals based on the selected date ranges.

5. The method as claimed in claim 1, wherein scoring the one or more determined slots comprises generating one or more heat maps based on the set of parameters.

6. The method as claimed in claim 1, wherein the set of parameters comprises:
a predefined buffer time associated with a user and an event type of a conflict event; and
another predefined buffer time associated with the user and an event type of the scheduling task.

7. The method as claimed in claim 1, wherein ranking the scored slots comprises ranking scored slots within a same date range.

8. The method as claimed in claim 1, further comprising:
presenting a subset of the ranked list of slots to one or more users;
determining a preferred slot based on the subset of the ranked list of slots; and
setting a task based on the preferred slot determined.

9. An automated task scheduling system, comprising:
at least one processor; and
a non-transitory computer-readable storage medium coupled to the at least one processor and storing programming instructions for execution by the at least one processor, the programming instructions instruct the at least one processor to perform the method of:
receiving a data input, wherein the data input is generated based on one or more user inputs;
determining one or more slots based on the data input, wherein each slot comprises a date range and a time interval;
scoring the one or more determined slots based on a set of parameters;
ranking the scored slots;
selecting one or more of the ranked slots based on rankings of the ranked slots; and
generating a ranked list of slots based on the one or more selected slots.

10. An automated task scheduling system, comprising a plurality of modules for:
receiving a data input, wherein the data input is generated based on one or more user inputs;
determining one or more slots based on the data input, wherein each slot comprises a date range and a time interval;
scoring the one or more determined slots based on a set of parameters;
ranking the scored slots;
selecting one or more of the ranked slots based on rankings of the ranked slots; and
generating a ranked list of slots based on the one or more selected slots.
